(19) United States
(12) Patent Application Publication
(10) Pub. No.: US 2010/0174818 A1
(43) Pub. Date: Jul. 8, 2010

(54) Input Service for Client Devices

(75) Inventors: Eric R. Soldan, Saratoga, CA (US); Marilyn Chen, Redmond, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,670

(22) Filed: Jan. 7, 2009

(51) Int. Cl. G06F 15/16

(52) U.S. Cl. 709/227

(57) ABSTRACT

An input service for client devices is described. In embodiment(s), a session request can be received at a network service from a client device to establish an input service session. An applicable character input service can be determined which is then utilized by the client device where the character input service generates a character input interface for display at the client device. The character input interface of the character input service is communicated to the client device from which characters can be selected for input, and character inputs are received from the client device when initiated via the character input interface. The character inputs can be resolved at the network service for display updates that are then communicated to the client device for display in the character input interface.

### BACKGROUND

Many computer devices include multiple software plug-in components for selection of different language-specific inputs and locale. For example, a user can select English as a language to enter and display text, and the United States as the locale that is associated with the selected English language. Because some devices have limited processing and memory capabilities, it may not be practical for many of the devices to include plug-in components for every different language input selection, or to add plug-in components as needed because they take up memory space. It may be likely, however, that some devices do need the language plug-in components to support multiple, different languages for different users because the devices are implemented in a shared environment, such as television client devices that support multiple languages in different locales.

### SUMMARY

This summary is provided to introduce simplified concepts of an input service for client devices. The simplified concepts are further described below in the Detailed Description. This summary is not intended to identify essential features of the claimed subject matter, nor is it intended for use in determining the scope of the claimed subject matter.

An input service for client devices is described. In embodiment(s), a session request can be received at a network service from a client device to establish an input service session. An applicable character input service can be determined by the network service which is then utilized by the client device where the character input service generates a character input interface for display at the client device. The character input interface of the character input service is communicated to the client device from which characters can be selected for input, and character inputs are received from the client device when initiated via the character input interface. The character inputs can be resolved at the network service for display updates that are then communicated to the client device for display in the character input interface.

In other embodiment(s) of an input service for client devices, a character input interface includes graphical elements that display as an on-screen keyboard at a client device that requests an input service session from a network service. Session parameters can also be received from the client device along with the session request to establish the input session service. The session parameters can include a language preference and a locale identifier for the character input interface, and/or can include a selected on-screen keyboard format and a screen size to display the on-screen keyboard. The session parameters can also include a user identifier that corresponds to one of multiple users of the client device.

In other embodiment(s) of an input service for client devices, a client device can request to establish an input service session with a network service, and then receive a character input interface from which characters can be selected for input to a character input service hosted at the network service. Graphical elements can be rendered to display the character input interface as an on-screen keyboard at the client device, and character inputs can be received as remote control device input selections via the character input interface. The character inputs can be communicated to the network service when received via the character input interface, and display updates are then received for display in the character input interface when the network service resolves the character inputs.

### BRIEF DESCRIPTION OF THE DRAWINGS

Embodiments of an input service for client devices are described with reference to the following drawings. The same numbers are used throughout the drawings to reference like features and components:

FIG. 1 illustrates an example system in which embodiments of an input service for client devices can be implemented.

FIG. 2 illustrates example method(s) for an input service for client devices in accordance with one or more embodiments, and is described with reference to a network service.

FIG. 3 illustrates example method(s) for an input service for client devices in accordance with one or more embodiments, and is described with reference to a client device.

FIG. 4 illustrates various components of an example device that can implement a character input interface for a character input service in accordance with one or more embodiments of an input service for client devices.

### DETAILED DESCRIPTION

Embodiments of an input service for client devices provide that a user can request a character input service that is hosted by a network service to enter text and characters in a particular language at a client device that does not otherwise support the language, such as with a plug-in module or component specific to the language. A character input service includes a character input interface for display at the client device, and character inputs that are initiated via the character input interface are communicated to an input service component of the character input service at the network service. The input service component resolves the character inputs to particular language characters, and display inputs can then be communicated to the client device for display in the character input interface.

A client device does not need to utilize memory space to store plug-in components for every different language input selection, or add additional plug-in components as needed. Additionally, updates to languages and/or locales are centralized at the network service, rather than having to provide updates directly to the many client devices that have language plug-in components.

While features and concepts of the described systems and methods for an input service for client devices can be implemented in any number of different environments, systems, and/or various configurations, embodiments of an input service for client devices are described in the context of the following example systems and environments.

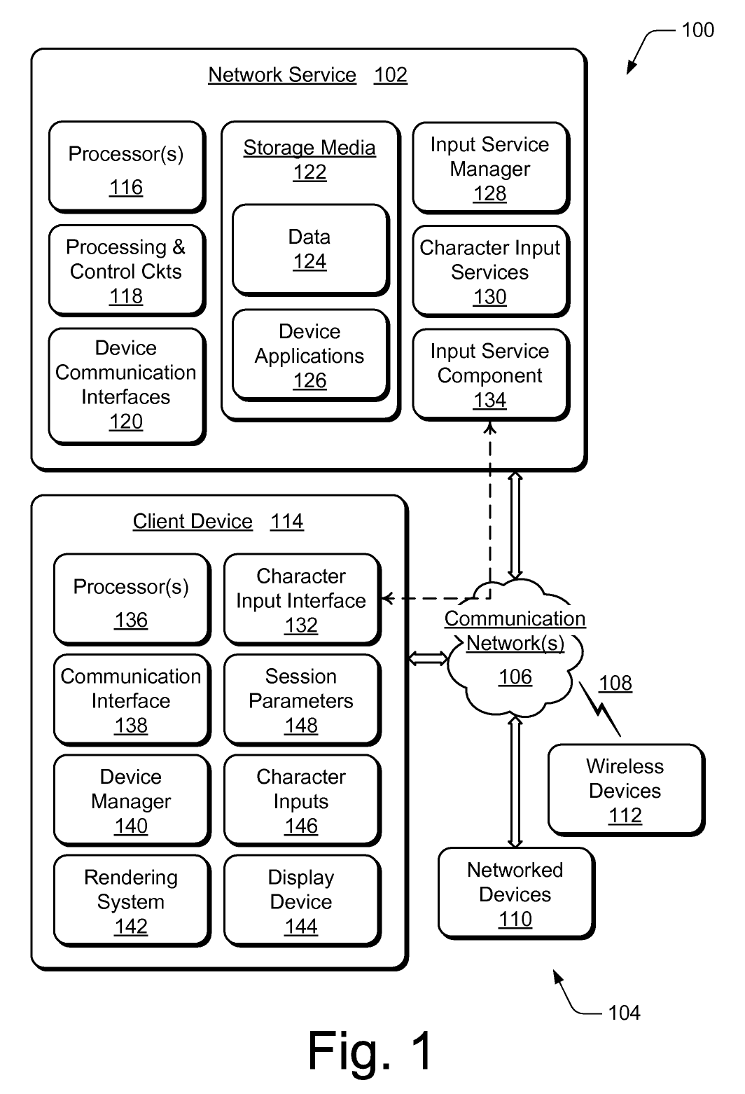

FIG. 1 illustrates an example system 100 in which various embodiments of an input service for client devices can be implemented. Example system 100 includes a network service 102 and various client devices 104 that are implemented for communication via one or more communication networks 106. The communication networks 106 can include any type of a data network, voice network, broadcast network, IP-based network, and/or a wireless network 108 that facilitates communication of data in any format. The communication networks 106 and wireless network 108 can be implemented using any type of network topology and/or communication protocol, and can be represented or otherwise implemented as a combination of two or more networks. In addition, any one or more of the arrowed communication links facilitate two-way data communication.

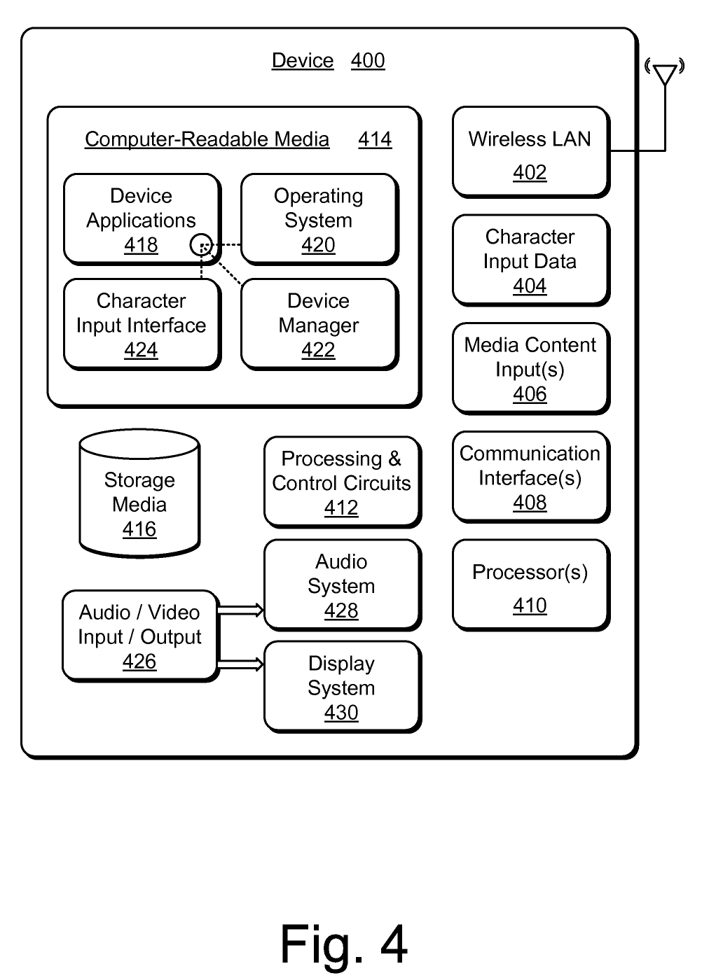

The various client devices 104 can include any type of networked devices 110 and/or wireless devices 112, such as example client device 114. The various client devices 104 can include any one or combination of a wired and/or wireless device, computer device, mobile phone device, portable computer device, media device, communication device, video processing and/or rendering device, television client device (e.g., a television set-top box, a digital video recorder (DVR), etc.), appliance device, gaming device, electronic device, and/or any other type of device that can be implemented to receive media content in any form of audio, video, and/or image data. Any of the client devices described herein can be implemented with one or more processors, communication components, data inputs, memory components, and/or processing and control circuits. A client device can also be implemented with any number and combination of differing components as described with reference to the example device shown in FIG. 4.

In this example system 100, network service 102 includes one or more processors 116 (e.g., any of microprocessors, controllers, and the like) that process various computer-executable instructions to implement embodiments of an input service for client devices. Alternatively or in addition, network service 102 can be implemented with any one or combination of hardware, firmware, or fixed logic circuitry that is implemented in connection with processing and control circuits which are generally identified at 118. Although not shown, network service 102 can include a system bus or data transfer system that couples the various components within the service.

Network service 102 also includes one or more device communication interfaces 120 that can be implemented as a serial and/or parallel interface, a wireless interface, any type of network interface, a modem, and/or as any other type of communication interface. The device communication interfaces 120 provide connection and/or communication links between network service 102 and the communication networks 106 (e.g., to include wireless network 108) by which to communicate with the various client devices 104.

Network service 102 also includes storage media 122 to store or otherwise maintain various data 124 and media content for distribution to the various client devices 104. The storage media 122 can be implemented as any type of memory, magnetic or optical disk storage, and/or other suitable electronic data storage. The storage media 122 can also be referred to or implemented as computer-readable media, such as one or more memory components, that provide data storage mechanisms to store various device applications 126 and any other types of information and/or data related to operational aspects of the network service 102. For example, an operating system and/or software modules and components can be maintained as computer applications with storage media 122 and executed on processors 116.

Network service 102 includes an input service manager 128 that manages character input services 130 that can be implemented as computer-executable instructions and executed by the processors 116 to implement embodiments of an input service for client devices. The input service manager 128 and the character input services 130 are examples of applications 126 that can be maintained by the storage media 122. Although illustrated and described as applications of network service 102, the input service manager 128 and the character input services 130, as well as other functionality to implement the various embodiments described herein, can be provided as a service apart from the network service 102 (e.g., on a separate server or by a third party service).

In various embodiments, the character input services 130 are hosted by the network service 102 and can each be requested by a client device 104 to configure the client device for character input in a particular language and/or locale without installing a component or plug-in module for each different language and/or locale on the client device. For example, a user of client device 114 may want to enter text in Arabic or Chinese characters, such as with remote control device inputs to a television set-top box, or with keyboard inputs to a portable computer device. The client device 114 can communicate a request to the network service 102 for a character input service 130 that is formatted for use by client device 114 to enter text in the characters of a different language.

A character, as described herein, can include any type of letter, number, symbol, alphanumeric input, identifier, words, phrases, and/or a combination of entries or representations that form a character. A character input service 130 includes a character input interface 132 for display at a client device from which characters can be selected for input. The client device 114 can host the graphical elements of a character input service 130 as the character input interface 132 that is displayed at the client device. The character input service 130 also includes an input service component 134 that can receive character inputs from the client device and resolve the character inputs to return display updates that are displayed on the character input interface 132 at client device 114.

In addition to a character input interface 132 that is associated with a particular character input service 130, client device 114 includes one or more processors 136 (e.g., any of microprocessors, controllers, and the like), and a communication interface 138 for communication with network service 102 and for other data communications. Client device 114 also includes a device manager 140 (e.g., a control application, software application, signal processing and control module, code that is native to a particular device, a hardware abstraction layer for a particular device, etc.).

Client device 114 includes a rendering system 142 to receive and render the character input interface 132 for display on a display device 144. The display device 144 can be implemented as any type of integrated display or external television, LCD, or similar display system. The character input interface 132 can be displayed for user interaction, such as for character inputs 146 initiated with a remote control device, a keypad, a keyboard, or other input device to select characters in a particular language that is associated with a particular character input service 130. In various implementations, a particular client device may not be able to render the characters of a particular language when a user inputs text in the language, such as if font rendering for the particular language is not available on a device. In an embodiment, graphics of the input characters can be communicated to the device for a representative presentation display of the characters. The input service component 134 can resolve character inputs and return any type of variable letter, number, symbol, alphanumeric input, identifier, graphic, and the like for presentation at the device. Embodiments of a character input service are not restricted if a client device is unable to render specific characters in specific languages and/or locales.

The character input interface 132 can be displayed as any type of character free-form input user interface, and can correlate to the type of input device that is associated with the client device. For example, a remote control device may only have up/down, left/right, and enter input keys for user selection of characters. In an embodiment, the character input interface 132 can be displayed as an on-screen keyboard that is optionally configured in any layout. For example, an on-screen keyboard designed to enter a combination of entries that form a Chinese character does not have to correlate to a standard English keyboard. Additionally, the characters displayed at a client device, as resolved for display by the input service component 134 of a character input service 130, may be independent from any font rendering capabilities of the client device. In various embodiments, the input service component 134 can be implemented to generate a glyph set for example, rather than images, to present character inputs at a client device that may not have the capability to utilize a large font, but that may have glyph rendering capabilities. For example, a glyph set that is generated for an input of Chinese characters can be generated so as not to display larger that the number of Chinese characters to present.

In various embodiments, the input service manager 128 at network service 102 can be implemented to receive a session request from the client device 114 to establish an input service session for a character input service 130. The input service manager 128 can also receive session parameters 148 from the client device 114 as part of the session request to establish the input service session. The session parameters 148 can be any type of information and/or attributes that include, but are not limited to, a language preference, a locale identifier (e.g., a language, country, and region adaptation), a format or style of an on-screen keyboard, a screen or display size in which to display the character input interface, other display parameters, an amount of text to be entered, a type of presentation markup (e.g., HTML, XHTML, etc.), and/or a user identifier or preference that corresponds to one of multiple users of a particular client device. The session parameters 148 can also include a parameter from which the input service manager 128 can determine rendering capabilities of the client device 114, such as when the client device initiates a session request.

The input service manager 128 can also be implemented to determine which of the character input services 130 is applicable for use by the client device, such as determined from the session parameters 148 and/or from the type of device that requests to establish an input service session. Once a character input service 130 has been determined, the input service manager 128 can initiate communication of graphical elements of the character input interface 132 to the client device for display.

The input service manager 128 can receive character inputs from the client device 114 when initiated via the character input interface 132 as character inputs 146 received at client device 114, such as remote control device input selections. The input service component 134 of the particular character input service 130 can be implemented to resolve the character inputs, such as to generate characters for display at the client device. The input service manager 128 can then initiate communication of the display updates to the client device 114 for display in the character input interface 132 on display device 144. The display updates can be incremental updates to the presentation as an indication of the character inputs that have been entered, such as a representation of a Chinese character that is resolved from multiple character inputs.

In other embodiments, a client device 104 can invoke a character input service 130 indirectly through another application, such as when searching or indexing into other content. For example, a user may be searching movie titles through a video-on-demand application via a television client device. The client device can communicate character selections to the video-on-demand application (e.g., a video storefront from which to order movies) that then communicates with the network service. The client device can then receive progressive markup from the network service via the video-on-demand application as the user navigates through the movie titles.

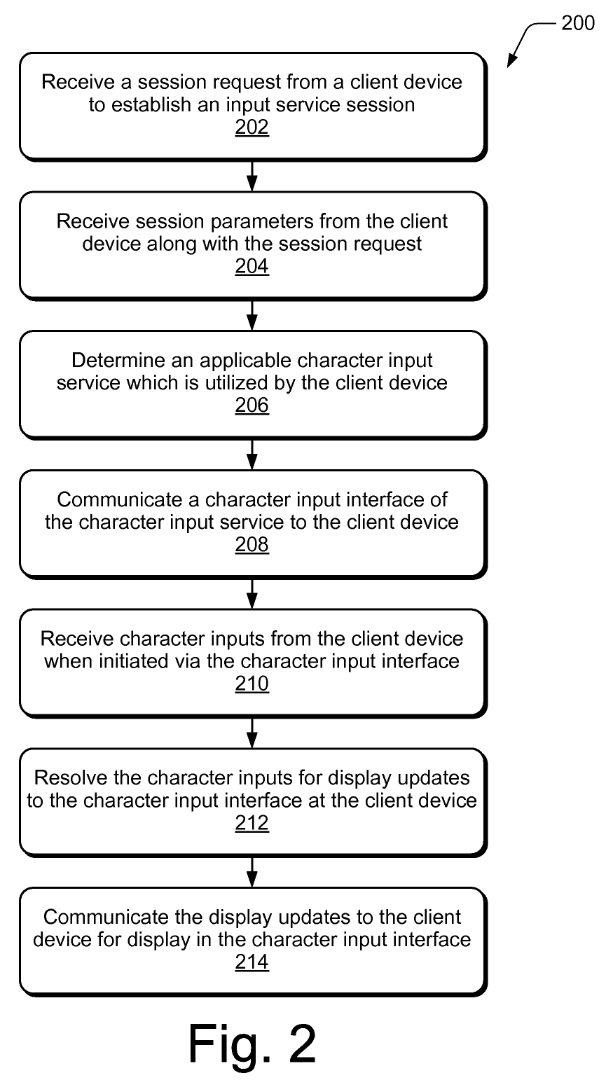

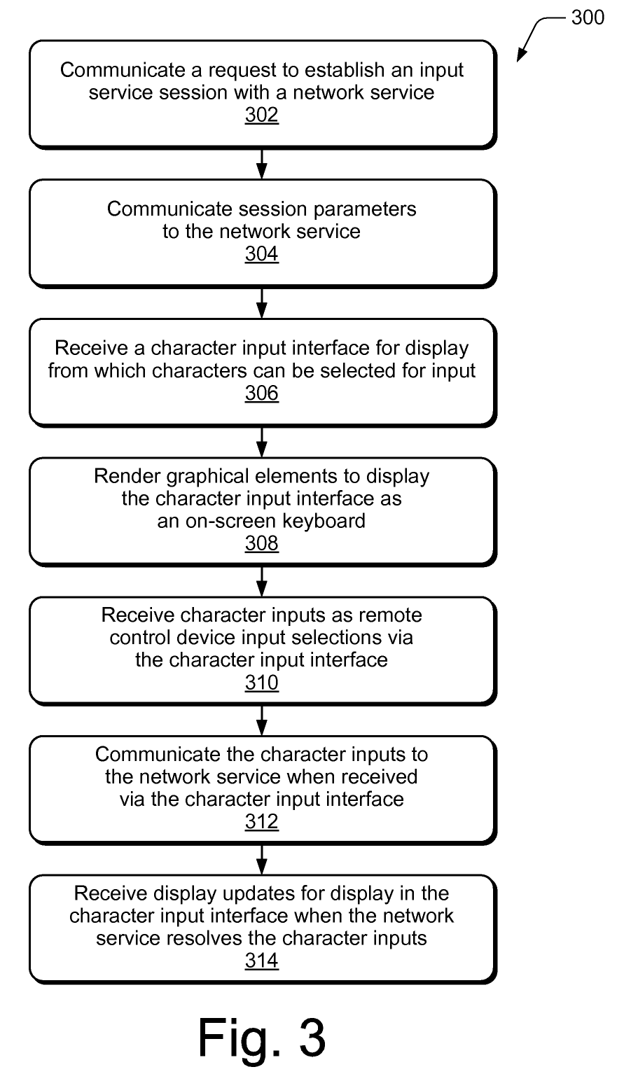

Example methods 200 and 300 are described with reference to respective FIGS. 2 and 3 in accordance with one or more embodiments of an input service for client devices. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The method(s) may be described in the general context of computer-executable instructions, which can include software, applications, routines, programs, objects, components, data structures, procedures, modules, functions, and the like.

The method(s) may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 2 illustrates example method(s) 200 for use of an input service for client devices, and is described with reference to a network service. The order in which the method is described is not intended to be construed as a limitation, and any number of the described method blocks can be combined in any order to implement the method, or an alternate method.

At block 202, a session request is received from a client device to establish an input service session. For example, input service manager 128 at network service 102 (FIG. 1) receives a session request from client device 114 to establish an input service session for a character input service 130. At block 204, session parameters are received from the client device along with the session request to establish the input session service. For example, input service manager 128 receives session parameters 148 from client device 114, such as a language preference and a locale identifier for the character input interface 132. Other session parameters can be received to include a selected on-screen keyboard format and a screen size to display the on-screen keyboard, and/or a user identifier that corresponds to one of multiple users of the client device.

At block 206, an applicable character input service is determined which is then utilized by the client device. For example, input service manager 128 determines which of the character input services 130 is applicable for use by the client device, such as determined from the session parameters 148 and/or from the type of device that requests to establish the input service session.

At block 208, a character input interface of the character input service is communicated to the client device. For example, the input service manager 128 initiates communication of graphical elements of character input interface 132 to the client device 114 for display and from which characters can be selected for input. The determined or selected character input service 130 includes the character input interface 132 for display at the client device, and in various embodiments, graphical elements of the character input interface are displayed as an on-screen keyboard.

At block 210, character inputs are received from the client device when initiated via the character input interface. For example, input service manager 128 receives character inputs from client device 114 when initiated via the character input interface 132 as character inputs 146 received at client device 114, such as remote control device input selections.

At block 212, the character inputs are resolved for display updates to the character input interface at the client device. For example, the input service component 134 of the particular character input service 130 resolves the character inputs to generate characters for display at the client device. At block 214, the display updates are communicated to the client device for display in the character input interface. For example, input service manager 128 initiates communication of the display updates to client device 114 for display in the character input interface 132 on display device 144. The display updates can be incremental updates to the presentation as an indication of the character inputs that have been entered.

FIG. 3 illustrates example method(s) 300 for use of an input service for client devices, and is described with reference to a client device. The order in which the method is described is not intended to be construed as a limitation, and any number of the described method blocks can be combined in any order to implement the method, or an alternate method.

At block 302, a request is communicated to establish an input service session with a network service. For example, client device 114 (FIG. 1) communicates a session request to network service 102 to establish an input service session for a character input service 130. At block 304, session parameters are communicated to the network service. For example, client device 114 also communicates session parameters 148 to network service 102 that are utilized to establish the input service session for a character input service 130.

At block 306, a character input interface is received for display from which characters can be selected for input. For example, client device 114 receives graphical elements of a character input interface 132 for display and from which characters can be selected for input. The character inputs 146 can then be communicated to a character input service hosted at the network service 102. At block 308, the graphical elements are rendered to display the character input interface as an on-screen keyboard. For example, the rendering system 142 at client device 114 renders the graphical elements to generate the character input interface 132 for display on display device 144.

At block 310, character inputs are received as remote control device input selections via the character input interface. For example, client device 114 receives character inputs 146, such as remote control device input selections. At block 312, the character inputs are communicated to the network service when received via the character input interface. For example, client device 114 communicates the character inputs 146 to the network service 102. At block 314, display updates are received for display in the character input interface when the network service resolves the character inputs. For example, client device 114 receives display updates that are resolved by the input service component 134 at network service 102 for display in the character input interface 132 on display device 144.

FIG. 4 illustrates various components of an example device 400 that can be implemented as any type of device described with reference to FIG. 1 to implement embodiments of an input service for client devices. In embodiments, device 400 can be implemented as any one or combination of a wired and/or wireless device, portable computer device, media device, computer device, communication device, video processing and/or rendering device, appliance device, gaming device, electronic device, and/or as any other type of device. Device 400 may also be associated with a user (i.e., a person) and/or an entity that operates the device such that a device describes logical devices that include users, software, firmware, and/or a combination of devices.

Device 400 includes wireless LAN (WLAN) components 402, that enable wireless communication of character input data 404 or other device content (e.g., received data, data that is being received, data scheduled for broadcast, data packets of the data, etc.). Device content can include configuration settings of the device, media content stored on the device, and/or information associated with a user of the device. Device 400 can also include one or more media content inputs 406 via which any type of media content can be received, such as music, television media content, recorded video content, and any other type of audio, video, and/or image content received from a content source which can be processed, rendered, and/or displayed for viewing.

Device 400 can also include communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices can communicate with device 400.

Device 400 can include one or more processors 410 (e.g., any of microprocessors, controllers, and the like) which process various computer-executable instructions to control the operation of device 400 and to implement embodiments of an input service for client devices. Alternatively or in addition, device 400 can be implemented with any one or combination of hardware, firmware, or fixed logic circuitry that is implemented in connection with processing and control circuits which are generally identified at 412.

Device 400 can also include computer-readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like. Device 400 may also include a mass storage media device 416.

Computer-readable media 414 provides data storage mechanisms to store the character input data 404 and other device content, as well as various device applications 418 and any other types of information and/or data related to operational aspects of device 400. For example, an operating system 420 can be maintained as a computer application with the computer-readable media 414 and executed on the processors 410. The device applications 418 can also include a device manager 422 and a character input interface 424 of a character input service. In this example, the device applications 418 are shown as software modules and/or computer applications that can implement various embodiments of an input service for client devices.

Device 400 can also include an audio, video, and/or image processing system 426 that provides audio data to an audio system 428 and/or provides video or image data to a display system 430. The audio system 428 and/or the display system 430 can include any devices or components that process, display, and/or otherwise render audio, video, and image data. The audio system 428 and/or the display system 430 can be implemented as integrated components of the example device 400. Alternatively, audio system 428 and/or the display system 430 can be implemented as external components to device 400. Video signals and audio signals can be communicated from device 400 to an audio device and/or to a display device via an RF (radio frequency) link, S-video link, composite video link, component video link, DVI (digital video interface), analog audio connection, or other similar communication link.

Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of an input service for client devices have been described in language specific to features and/or methods, it is to be understood that the subject of the appended claims is not necessarily limited to the specific features or methods described. Rather, the specific features and methods are disclosed as example implementations of an input service for client devices.

1. An input service system, comprising:
character input services each configured for request by a client device, a character input service including a character input interface for display at the client device from which characters can be selected for input, the character input service further including an input service component configured to resolve character inputs for display updates to the character input interface at the client device;
an input service manager configured to:
receive a session request from the client device to establish an input service session;
initiate communication of the character input interface of the character input service to the client device for display;
receive the character inputs from the client device when initiated via the character input interface; and
initiate communication of the display updates to the client device for display in the character input interface.

2. An input service system as recited in claim 1, wherein the input service manager is further configured to receive the session request from the client device and determine which of the character input services is applicable for use by the client device.

3. An input service system as recited in claim 1, wherein the character input interface includes graphical elements configured for display at the client device as an on-screen keyboard.

4. An input service system as recited in claim 1, wherein the input service manager is further configured to receive session parameters from the client device as part of the session request to establish the input service session.

5. An input service system as recited in claim 4, wherein the session parameters received from the client device include a language preference and a locale identifier for the character input interface of the character input service.

6. An input service system as recited in claim 4, wherein the session parameters received from the client device include a selected on-screen keyboard format and a screen size to display the on-screen keyboard.

7. An input service system as recited in claim 4, wherein the session parameters received from the client device include a user identifier that corresponds to one of multiple users of the client device.

8. An input service system as recited in claim 4, wherein the session parameters received from the client device include a parameter from which the input service manager is further configured to determine rendering capabilities of the client device.

9. An input service system as recited in claim 1, wherein the input service manager is further configured to receive the character inputs from the client device as remote control device input selections.

10. An input service system as recited in claim 1, wherein the input service component of the character input service is further configured to resolve the character inputs as they are received, and wherein the input service manager is further configured to initiate communication of the display updates to the client device as progressive updates for display.

11. A method, comprising:
receiving a session request from a client device to establish an input service session;
determining a character input service which is then utilized by the client device, the character input service including a character input interface for display at the client device;
communicating the character input interface of the character input service to the client device from which characters can be selected for input;
receiving character inputs from the client device when initiated via the character input interface;
resolving the character inputs for display updates to the character input interface at the client device; and
communicating the display updates to the client device for display in the character input interface.

12. A method as recited in claim 11, wherein the character input interface includes graphical elements that display at the client device as an on-screen keyboard.

13. A method as recited in claim 11, further comprising receiving session parameters from the client device with the session request to establish the input session service.

14. A method as recited in claim 13, wherein the session parameters include a language preference and a locale identifier for the character input interface of the character input service.

15. A method as recited in claim 13, wherein the session parameters include a selected on-screen keyboard format and a screen size to display the on-screen keyboard.

16. A method as recited in claim 13, wherein the session parameters include a user identifier that corresponds to one of multiple users of the client device.

17. A method as recited in claim 11, wherein the character inputs are received from the client device as remote control device input selections.

18. A method, comprising:
requesting to establish an input service session with a network service;
receiving a character input interface for display from which characters can be selected for input to a character input service hosted at the network service;
communicating character inputs to the network service when received via the character input interface; and
receiving display updates for display in the character input interface, the display updates being received from the network service that resolves the character inputs.

19. A method as recited in claim 18, rendering graphical elements to display the character input interface as an on-screen keyboard.

20. A method as recited in claim 18, further comprising communicating session parameters to the network service when said requesting to establish the input service session, the session parameters including a language preference and a locale identifier for the character input interface of the character input service.
